(19) United States
(12) Patent Application Publication
(10) Pub. No.: US 2026/0252022 A1
(43) Pub. Date: Aug. 27, 2026

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventors: TOSHIFUMI OIKAWA, Ibaraki (JP); HIROYUKI EDA, Ibaraki (JP); HIROKI KOBAYASHI, Ibaraki (JP); KAZUHIRO AKIBA, Chiba (JP)

(21) Appl. No.: 19/532,853

(22) Filed: Feb. 6, 2026

(30) Foreign Application Priority Data
Feb. 25, 2025 (JP) 2025-028108

(51) Int. Cl. G03G 15/00; G03G 15/02

(52) U.S. Cl. CPC G03G 15/6573; G03G 15/0291; G03G 15/5004; G03G 15/5029

(57) ABSTRACT

An image forming apparatus includes an operation unit that selects whether to use a first charge removal setting value set by an operation unit to perform the charge removal processing on a sheet with an image printed thereon by a printer unit or use a second charge removal setting value for the sheet with the image printed thereon, out of the stored charge removal setting values, and performs the charge removal processing on the sheet with the image printed thereon by the printer unit.

### BACKGROUND

### Field of the Technology

The present disclosure relates to an image forming apparatus, a method for controlling the image forming apparatus, and a storage medium.

### Description of the Related Art

A recording medium (hereinafter referred to as a “sheet”) used for a print operation is conveyed in a state of being charged with static electricity due to residual charge generated in an electrophotographic process or slight friction with conveyance rollers or guides during conveyance of the sheet. This static electricity may cause sheets to stick to each other. Further, dust or paper dust may attach to a printed product, leading to a reduction in the product quality.

Plain paper or similar types of paper have low electric resistance in the sheet itself, allowing charge to move easily within the sheet. Thus, the amount of charge is low and the charge dissipates quickly. In contrast, other types of sheets, such as thick paper, synthetic paper, and coated paper, in which a synthetic resin (plastic) is used, have high electric resistance in the sheet itself, and thus, charge does not easily move within the sheet. As a result, these types of sheets, such as synthetic paper and coated paper, are more easily charged, and the charge tends to remain. Further, it is generally known that these types of sheets, such as synthetic paper and coated paper, are susceptible to the environment, in particular, humidity, and are apt to be charged with static electricity because of a lower amount of discharge in environments with lower humidity. Plain paper or similar types of paper with high moisture content are susceptible to humidity, but have a small amount of charge. In contrast, sheets made with synthetic resin with low moisture content are less affected by humidity, but are apt to be charged.

If post-processing were performed on sheets that were sticking to each other, the sticking sheets would be likely to affect sheet alignment processing, not only degrading the quality of the post-processing, but causing a paper jam due to sheet feed failure or conveying failure during the post-processing.

For that reason, in order to avoid the issue, it is desirable to remove static electricity from the sheets subjected to printing processing before the post-processing is performed. Thus, a technique is described of neutralizing electric charge on a sheet by applying a voltage to a pair of conveyance rollers disposed downstream in the sheet conveyance direction (refer to Japanese Patent Laid-Open No. 1999-258881).

The charge removal method including applying a voltage to a pair of conveyance rollers (hereinafter, referred to as “charge removal rollers”) is of neutralizing charged static electricity by applying charge with a polarity opposite to that of the charge on the sheets to the sheets via the charge removal rollers. Thus, charge removal control using the charge removal rollers (the application of charge with the polarity opposite to that of the charge on the sheet to the charge removal rollers) needs to be performed based on the amount of charge on the sheet. This is because an optimum charge adjustment value for charge removal exists for a print environment, such as humidity, or the sheet corresponding to a sheet product name.

Regarding a configuration for the optimal charge removal adjustment, first, with a component basically provided that allows adjustment using hardware, a sheet to be used is fed, the amount of charge on the sheet corresponding to the product name is measured, and a charge removal adjustment value is set. By repeating the measurement and adjustment operation until sheet adhesion is eliminated, it is possible to determine the optimum charge removal adjustment value (a hardware charge removal adjustment value) even without knowing the product name of the sheets to be used.

On the other hand, there are product names that are preliminarily registered in an image forming apparatus. For the sheet corresponding to the product name to be used that matches a registered product name, an optimum charge removal adjustment value to be adjusted using software is prepared in advance in the image forming system, and thus, the hardware charge removal adjustment value is not required to be set. Further, the image forming apparatus includes sheets corresponding to a plurality of registered product names, and the optimum charge removal adjustment value is switched using software every time a sheet type is selected.

### SUMMARY

According to an aspect of the present disclosure, an image forming apparatus includes a printer unit configured to print an image on a sheet, a control unit configured to cause a charge removal device to perform charge removal processing on the sheet with the image printed thereon by the printer unit, the charge removal device having an operation unit configured to be operable by a user, and a storage device configured to store charge removal setting values each corresponding to one sheet type, wherein the operation unit selects whether to use a first charge removal setting value set by the operation unit to perform the charge removal processing on the sheet with the image printed thereon by the printer unit or use a second charge removal setting value for the sheet with the image printed thereon, out of the charge removal setting values stored in the storage device, to perform the charge removal processing on the sheet with the image printed thereon by the printer unit.

Features of various embodiments will become apparent from the following description of embodiments with reference to the attached drawings. The following description of embodiments is described by way of example.

### BRIEF DESCRIPTION OF THE DRAWINGS

FIG. 1 is a diagram illustrating a minimum configuration of a system according to an embodiment.

FIG. 2 is a block diagram illustrating a hardware configuration of a printing device.

FIG. 3 is a cross-sectional view of an image forming apparatus.

FIG. 4 is a view illustrating an operation unit included in the printing device.

FIG. 5 is a system block diagram of a charge removal device.

FIG. 6 is a view illustrating an operation unit included in the charge removal device.

FIG. 7 is a schematic diagram for describing charge removal processing.

FIG. 8 is a flowchart illustrating a charge removal control method for switching a charge removal adjustment value before printing.

FIG. 9 is a flowchart illustrating a charge removal control method for switching the charge removal adjustment value during printing.

### DESCRIPTION OF THE EMBODIMENTS

### First Embodiment

A first embodiment will now be described with reference to the attached drawings.

The following embodiment is not intended to limit the scope of the claims, and not all combinations of features described in the embodiment are necessarily essential to the solutions provided by the disclosure.

### Hardware Configuration

### (General Configuration of System)

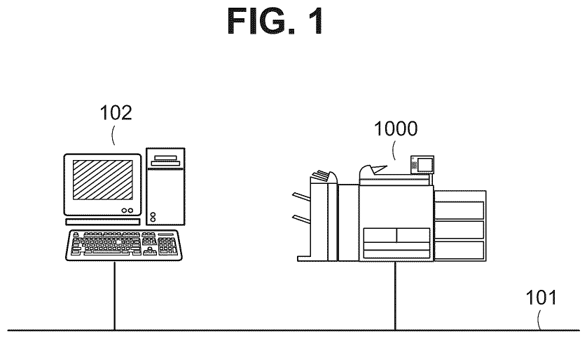

FIG. 1 illustrates a configuration in a simplest form according to the present embodiment. The configuration includes an image forming apparatus 1000 and a client computer 102 (hereinafter, referred to as a “personal computer (PC) 102”), which are connected to each other via a network 101. The PC 102 is capable of transmitting page description language (PDL) code data as a print job to the image forming apparatus 1000 via the network 101.

### (Image Forming Apparatus)

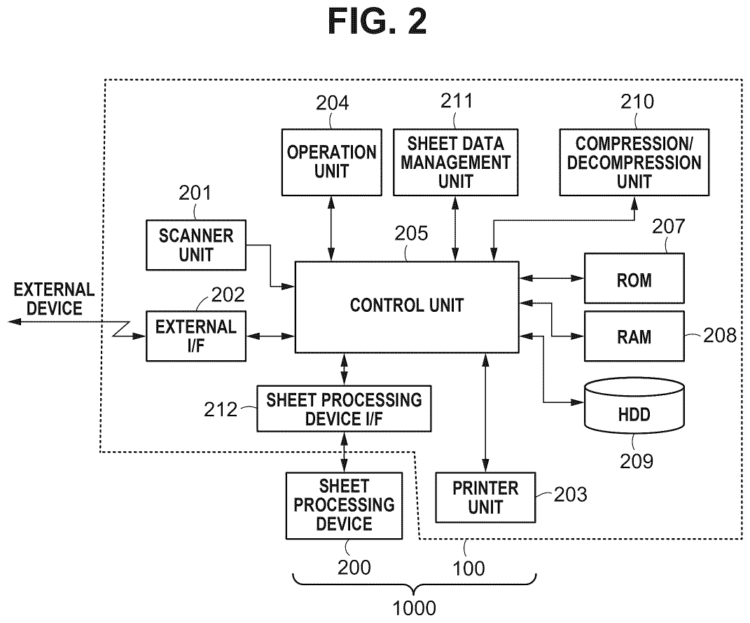

A hardware configuration of the image forming apparatus 1000 will now be described with reference to a system block diagram illustrated in FIG. 2. The image forming apparatus 1000 includes a printing device 100, which is represented by a section enclosed by dotted lines in FIG. 2, and a sheet processing device 200.

In the present embodiment, the printing device 100 and the sheet processing device 200 transmit and receive information via a sheet processing device interface (I/F) 212.

Any desired number of sheet processing devices 200 can be connected to the printing device 100. In a case where a plurality of sheet processing devices 200 is connected to the printing device 100, the sheet processing device I/F 212 is provided between the sheet processing devices 200 to transmit and receive information. In the present embodiment, an example will be described of, as the printing device 100, a multi-function peripheral (MFP) having a plurality of functions, such as a copy function and a printer function. However, the printing device 100 may be a single function printing device having only a copy function or a printer function. In the present embodiment, as an example, the image forming apparatus 1000 is assumed to include various components described in the following.

The image forming apparatus 1000 is configured to perform sheet processing on the sheets printed by the printing device 100 using the sheet processing device 200 connected to the printing device 100. However, the image forming apparatus 1000 can be configured only using the printing device 100 without connecting the sheet processing device 200 to the printing device 100. The sheet processing device 200 is configured to be communicable with the printing device 100 via the sheet processing device I/F 212. The sheet processing device 200 is capable of receiving instructions from the printing device 100 to execute sheet processing described below.

A scanner unit 201 reads an image on a document, converts the image into image data, and transfers the image data to another unit.

An external I/F 202 transmits data to and receives data from another device connected to the network 101.

A printer unit 203 prints an image on a sheet based on the input image data.

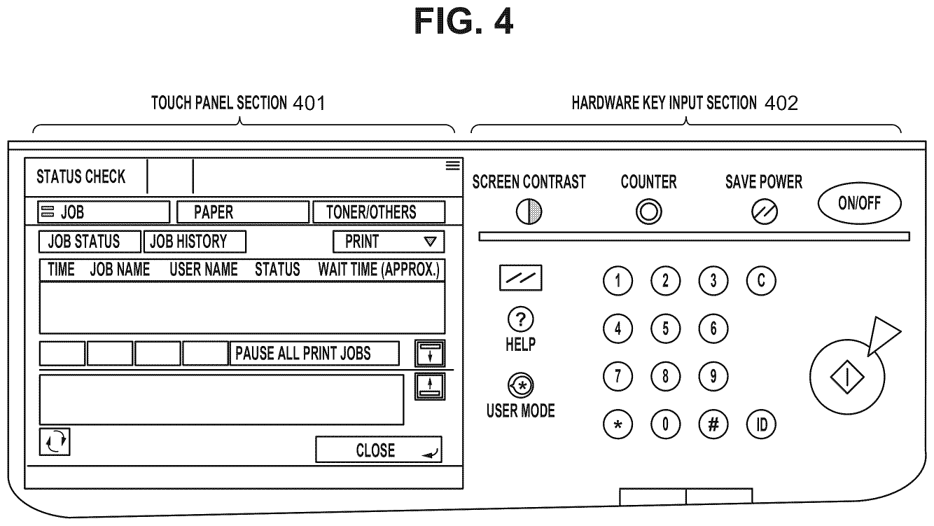

An operation unit 204 has a configuration as illustrated in FIG. 4 and includes a hardware key input section (key input section) 402 and a touch panel section 401 to receive instructions from a user via the key input section 402 and the touch panel section 401. Further, the operation unit 204 performs various types of display on the touch panel section 401 included in the operation unit 204.

A control unit 205 generally controls the processing, the operations, and the like of the units included in the image forming apparatus 1000, and is specifically a central processing unit (CPU).

A read only memory (ROM) 207 stores therein various kinds of computer programs executed by the control unit 205.

For example, the ROM 207 stores programs for causing the control unit 205 to execute various types of processing of flowcharts described below, or the ROM 207 stores a display control program for displaying various setting screens. The ROM 207 also stores a program for causing the control unit 205 to interpret the PDL code data received from the PC 102 to convert the data into raster image data. Further, the ROM 207 stores a boot sequence, font information, and the like.

A random access memory (RAM) 208 stores the image data and the PDL code data transmitted from the scanner unit 201 and the external I/F 202, various types of programs loaded from the ROM 207, and setting information.

A hard disk drive (HDD) 209 includes a hard disk and a drive unit to read data from and write data to the hard disk. The HDD 209 is a large-capacity storage device for storing image data, which is input from the scanner unit 201, compressed by a compression and decompression unit 210. The control unit 205 is capable of causing the printer unit 203 to print the image data stored in the HDD 209 based on an instruction from the user. Further, the HDD 209 is used also as a spooler, and the control unit 205 manages the PDL code data received from the PC 102 as print jobs and stores the data in the HDD 209. Further, the control unit 205 is capable of managing print jobs stored in the HDD 209 and also of obtaining the number of stored print jobs and the setting information set for the print jobs.

The compression and decompression unit 210 compresses and decompresses the image data and the like stored in the RAM 208 and the HDD 209 using various types of compression methods, such as Joint Bi-level Image Experts Group (JBIG) and Joint Photographic Experts Group (JPEG).

A sheet data management unit 211 manages information regarding control parameters used at the time of performing printing on sheets, information regarding charge removal control parameters, and information regarding environmental change impact for the type of each sheet and for the product name of each sheet. Examples of the control parameters include information, such as a sheet grammage, a surface property, and an adjustment value of a charge removal bias during charge removal control. Further, while the sheet data management unit 211 is illustrated in this manner as a part of the block diagram, the sheet data management unit 211 is actually a database in which a sheet information table is stored, and the database itself is stored in the HDD 209.

In the present embodiment, a specific example of the sheet information table will now be shown in Table 1, but the information structure or the like is not limited to the example.

TABLE 1

| | | Surface | Charge removal |
|---|---|---|---|
| Product name | Grammage | property | adjustment value |
| XX synthetic paper | 210 | Polypropylene | −3000 |
| YY synthetic paper | 180 | Polyester | −2700 |
| ZZ plain paper | 70 | Fine quality | −200 |
| | | paper | |

Product names of sheets registered in the image forming apparatus 1000 are shown in the column for product names on the above-shown sheet information table. Grammages each representing the thickness of each sheet are shown in the column for grammages. Further, information regarding sheet surface properties, such as “fine quality paper” and “polypropylene”, is shown in the column for surface properties. Charge removal adjustment values of charge removal biases to be applied to sheets corresponding to registered product names are stored in the column for charge removal adjustment values.

The control unit 205 is configured to access the sheet information table via the sheet data management unit 211 to acquire characteristic information regarding the sheet used in printing, control parameters used in printing, and information regarding charge removal control parameters.

### Hardware Configuration of Image Forming Apparatus

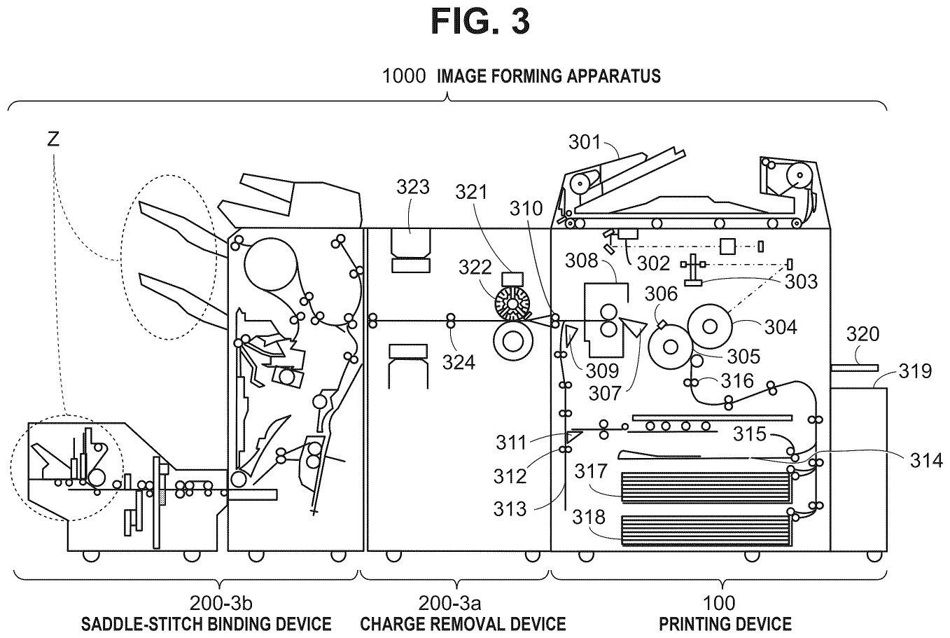

A hardware configuration of the image forming apparatus 1000 will now be described with reference to FIG. 3. FIG. 3 is a cross-sectional view illustrating the printing device 100 and the sheet processing device 200 connected to the printing device 100. In FIG. 3, the sheet processing device 200 includes a charge removal device 200-3a and a saddle-stitch binding device 200-3b.

### (Printing Device)

The printing device 100 will now be described.

An automatic document feeder (ADF) 301 sequentially separates a bundle of sheets of a document placed on the placement surface of a document tray from the first page in the page order to convey the sheets one by one onto a platen glass to be scanned by a scanner 302.

The scanner 302 reads images of the document conveyed onto the platen glass to convert the read image into image data using a charge-coupled device (CCD) sensor.

A rotating polygonal mirror 303 (polygon mirror, etc.) receives a light beam, for example, a laser beam modulated based on the image data to irradiate a photosensitive drum 304 with the laser beam as reflected scanning light via a reflection mirror.

A latent image formed on the photosensitive drum 304 by the laser beam is developed with toner, and the toner image is transferred to a sheet stuck on a transfer drum 305. A series of image forming operations is performed for yellow (Y), magenta (M), cyan (C), and black (K) toners to form a full color image. After the four image forming operations, the sheet with the full-color image formed thereon on the transfer drum 305 is separated from the transfer drum 305 by a separation pawl 306 to be conveyed to a fixing device 308 by a pre-fixing conveyer 307. The fixing device 308, provided with a combination of rollers and a belt, contains a heat source, such as a halogen heater, and melts to fix the toners as the transferred toner image on the sheet using heat and pressure. A sheet ejection flapper 309, which is configured to be swingable about a swing shaft, controls the sheet conveyance direction. When the sheet ejection flapper 309 pivots in the clockwise direction in the drawing, the sheet is conveyed straight and ejected to the outside of the printing device 100 by sheet ejection rollers 310. The control unit 205 controls the printing device 100 to perform one-sided printing through the series of sequences described above.

### (Double-Sided Printing)

On the other hand, in a case where images are formed on both sides of the sheet, the sheet ejection flapper 309 pivots in the counterclockwise direction in FIG. 3 to change the conveyance direction of the sheet downward to convey the sheet to a double-sided conveyance unit. The double-sided conveyance unit includes a reversing flapper 311, reversing rollers 312, a reversing guide 313, and a double-sided tray 314. The reversing flapper 311 swings about a swing shaft to control the sheet conveyance direction. In a case where a double-sided print job is processed, the control unit 205 controls the reversing flapper 311 to pivot in the counterclockwise direction in FIG. 3 to convey the sheet with a first surface subjected to printing by the printer unit 203 to the reversing guide 313 via the reversing rollers 312. The control unit 205 then temporarily stops the reversing rollers 312 with the trailing edge of the sheet nipped between the reversing rollers 312, and subsequently causes the reversing flapper 311 to pivot in the clockwise direction in FIG. 3. In addition, the control unit 205 rotates the reversing rollers 312 in the opposite direction. Through this operation, the control unit 205 controls the sheet to be conveyed in a switchback manner to be guided to the double-sided tray 314 with the trailing and leading edges of the sheet reversed.

The sheet is once placed in the double-sided tray 314 and then is conveyed to a registration roller 316 again by a sheet re-feed roller 315. In this case, the sheet is being conveyed with the surface (a second sheet surface) opposite to the first surface subjected to the transfer processing facing the photosensitive drum 304. Then, as in the process described above, an image for the second sheet surface is formed on the second sheet surface. The images are formed on both surfaces of the sheet, and the sheet goes through the fixing processing and then is ejected to the outside of the printing device 100 via the sheet ejection rollers 310.

The control unit 205 controls the printing device 100 to perform the double-sided printing throughout the series of sequences described above.

Further, the printing device 100 includes sheet feed units that store sheets for printing processing. The sheet feed units include sheet feed cassettes 317 and 318 (e.g., each of the cassettes may have a capacity of 500 sheets), a sheet feed deck 319 (e.g., the deck may have a capacity of 5,000 sheets), a manual sheet feed tray 320, and other similar type of unit. Sheets of various sizes and materials can be separately loaded in the corresponding sheet feed unit of the sheet feed units (the sheet feed cassettes 317 and 318, and the sheet feed deck 319). Further, various types of sheets including special sheets, such as an overhead projector (OHP) sheet, can be placed in the manual sheet feed tray 320.

### (Charge Removal Device)

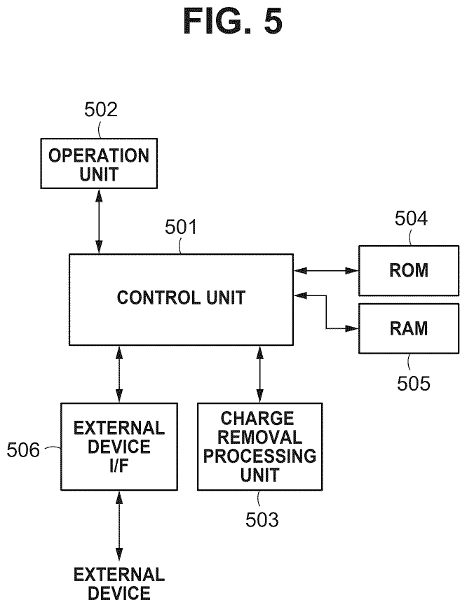

The charge removal device 200-3a will now be described. FIG. 5 is a system block diagram of the charge removal device 200-3a. The charge removal device 200-3a also includes a control unit 501 as a CPU. The control unit 501 generally manages the entire charge removal device 200-3a while communicating with the control unit 205 of the printing device 100 illustrated in FIG. 2 via an external device I/F 506.

### <Operation Unit>

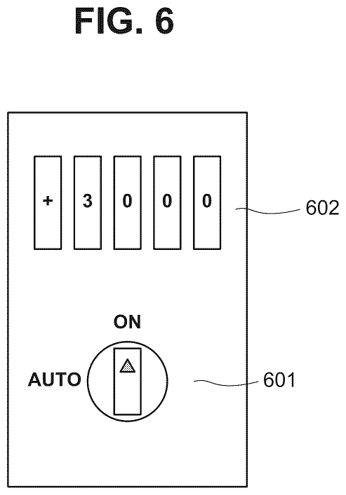

An operation unit 502 has a configuration as illustrated in FIG. 6 and includes two hardware switches, which are a mode setting switch 601 and an adjustment dial 602 as a thumb rotary switch.

When the mode setting switch 601 as a hardware switch is set at ON, the adjustment dial 602 adjusts the intensity of a charge removal control. The adjustment dial 602 is controlled by the control unit 501 so as to be enabled only when the mode setting switch 601 is set at ON.

In contrast, when the mode setting switch 601 as the hardware switch is set at AUTO, a charge removal adjustment value is enabled for a sheet having the same product name as that registered in the sheet data management unit 211.

A manner of switching ON and AUTO will be described below.

When printing is started, the control unit 501 receives print information (the size, the product name of the sheet, the conveyance speed, and the like) from the printing device 100 via the external device I/F 506, and the control unit 501 determines the charge removal control based on a print condition to control a charge removal processing unit 503.

The charge removal processing unit 503, which includes a voltage application controller 321 for both a charge removal roller 322 and an ionizer 323 described below, is configured to perform charge removal processing on a conveyed sheet. The control unit 501 performs control to apply voltages to the charge removal roller 322 and the ionizer 323 via the voltage application controller 321.

A ROM 504 stores a boot program for the charge removal device 200-3a, a control program for the operation unit 502, a charge removal processing program for the charge removal processing unit 503, and the like. The control unit 501 then loads a required program as appropriate from the ROM 504 into a RAM 505 to execute the loaded program.

### (Charge Removal Processing)

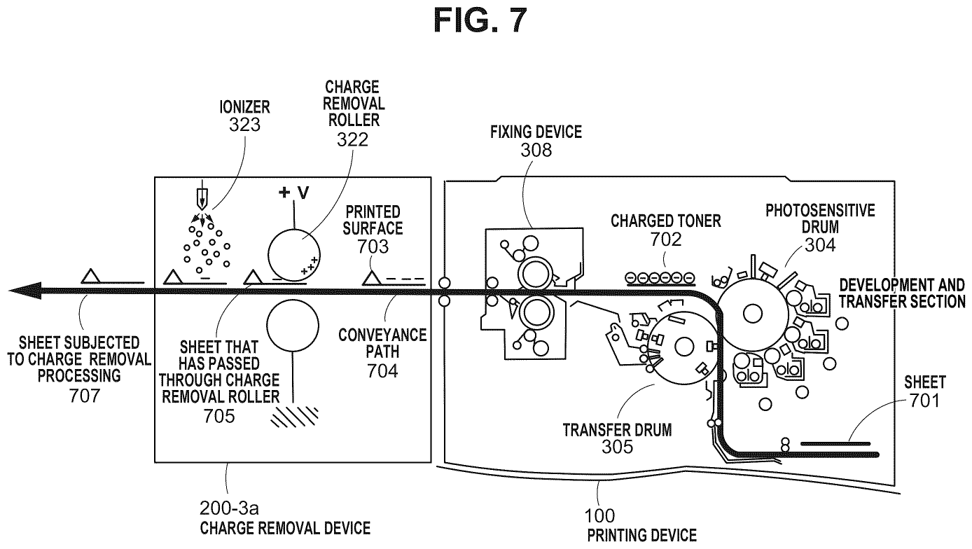

The charge removal processing performed by the charge removal processing unit 503 will now be described with reference to FIG. 7. FIG. 7 is a schematic diagram illustrating a state where the charge removal processing is performed by the charge removal device 200-3a on a sheet subjected to printing processing by the printing device 100. Further, components common to those in FIG. 3 are denoted by the same numbers. First, a sheet 701 is conveyed via a conveyance path 704 to a development and transfer section that contains the photosensitive drum 304 and the transfer drum 305, and a toner image is transferred to the sheet 701. Charged toner 702 on the sheet 701 is negatively charged, and the sheet with the toner image fixed thereto by the fixing device 308 is conveyed to the charge removal device 200-3a in a state where the toner on a printed surface 703 of the sheet 701 is negatively charged. The charge removal device 200-3a includes the charge removal roller 322, which is being positively charged, and the charge removal roller 322 applies positive charge to the negatively charged printed surface 703 in contact with the charge removal roller 322 to neutralize the charged state. However, it is possible that negative charge that has not been completely removed through the charge removal processing using the charge removal roller 322 or positive charge opposite in polarity to the charge on the sheet could remain on a sheet 705 that has passed through the charge removal roller 322. Thus, the charge removal device 200-3a described in the present embodiment is configured to further include the ionizer 323 downstream of the charge removal roller 322. The ionizer 323 applies a voltage to an electrode needle included in the ionizer 323 to generate corona discharge to remove charge using ions generated by the corona discharge. In this manner, by the charge removal roller 322 performing rough charge removal and ionizer 323 adjusting the residual charge, a sheet 707 subjected to the charge removal processing ejected from the charge removal device 200-3a is in a state where the charge is neutralized.

Returning to the description with reference to the cross-sectional view in FIG. 3, the charge removal device 200-3a includes the charge removal roller 322 and its paired roller. The sheet conveyed to the charge removal device 200-3a is conveyed while being nipped between the charge removal roller 322 and the paired roller to be subjected to the above-described rough charge removal by the charge removal roller 322. The ionizer 323 then performs the charge removal processing on the residual charge while the sheet is being conveyed by a conveyance roller 324 to the outside of the charge removal device 200-3a.

### (Saddle-Stitch Binding Device)

The saddle-stitch binding device 200-3b will now be described. Examples of the sheet processing performed by the saddle-stitch binding device 200-3b include saddle-stitch binding, punching processing, cutting processing, sheet shifted ejection processing, folding processing, and stapling processing. In the present embodiment, these jobs are collectively referred to as a “saddle-stitch binding job”.

In a case where a saddle-stitch binding job is processed, first, the control unit 205 causes the saddle-stitch binding device 200-3b to convey the sheet subjected to printing by the printing device 100 and to perform the sheet processing for the job. The control unit 205 then causes a corresponding sheet ejection destination portion Z of the saddle-stitch binding device 200-3b to hold the printed product of the saddle-stitch binding job, which is subjected to the sheet processing performed by the saddle-stitch binding device 200-3b. In addition, as a sheet ejection destination portion Z, there is a plurality of sheet ejection destination candidates. This is why the saddle-stitch binding device 200-3b can perform a plurality of types of sheet processing, and each of the sheet ejection destination portions is used when sheets are each sorted to the corresponding sheet ejection destination portion every time the sheet processing is performed. In the present embodiment, a detailed conveyance procedure of the saddle-stitch binding job will be omitted.

### Operation of Switching Charge Removal Adjustment Value

A description will be given of the method for switching the charge removal adjustment value of a charge removal bias applied by the charge removal device 200-3a according to the present embodiment and of the switching operation performed by the user.

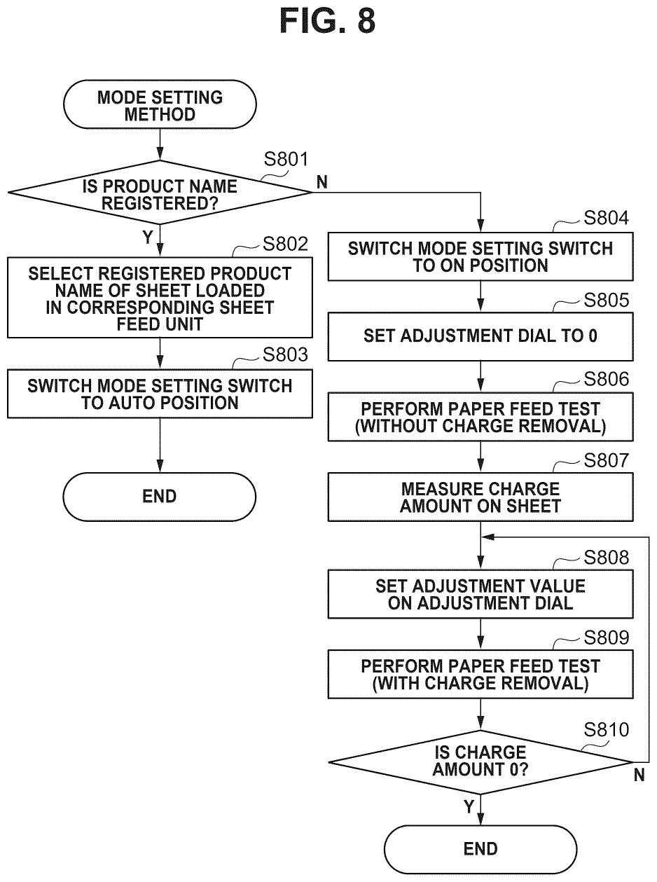

FIG. 8 illustrates a processing procedure of an operation performed by the user to configure a setting for the mode setting switch 601 as the hardware switch of the charge removal device 200-3a before printing.

In step S801, the user checks whether the product name of a sheet to be used is registered in the sheet data management unit 211.

Although not illustrated, it is assumed that the user can check whether the product name of a sheet to be used is registered by operating the operation unit 204 (FIG. 4).

### (In Case of Using Sheet Corresponding to Registered Product Name)

If the product name of a sheet to be used is registered (YES in step S801), the processing proceeds to step S802.

In step S802, the user selects the registered product name of the sheet loaded in the corresponding sheet feed unit.

In step S803, the user switches the mode setting switch 601 to the AUTO position, and the processing procedure of the operation ends.

### (In Case of Using Sheet Corresponding to Non-registered Product Name)

In contrast, if the sheet corresponding to a product name that is not registered in the sheet data management unit 211 is to be used (NO in step S801), the processing proceeds to step S804. Since sheet properties of the product name of the sheet have not been previously used, the user subsequently configures a setting for the charge removal adjustment value by actually feeding the sheet to measure the amount of charge on the sheet.

In step S804, the user first switches the mode setting switch 601 to the ON position.

In step S805, the user sets a value of the adjustment dial 602 to zero.

In step S806, the user performs a paper feed test. The user sets the product name of a sheet to be loaded in the sheet feed cassette 317 or 318 via the operation unit 204, and the user issues an instruction to start a printing operation on the sheet. In this case, the control unit 501 of the charge removal device 200-3a causes the charge removal processing unit 503 to output the image-formed sheet with no charge removal bias applied based on the state of the mode setting switch 601 and a value of zero as the value for the adjustment dial 602.

In step S807, the user measures the amount of charge on the output sheet using a charge amount measurement device, which is prepared and different from the image forming apparatus 1000.

In step S808, the user sets the charge removal adjustment value of the charge removal bias using the adjustment dial 602 based on the amount of charge measured by the charge amount measurement device in step S807.

In step S809, the user performs the paper feed test again, and the control unit 501 of the charge removal device 200-3a sets a value as the charge removal adjustment value of the charge removal bias using the adjustment dial 602 to apply the charge removal bias to remove charge.

In step S810, the user checks whether the output sheet is no longer charged (whether the amount of charge is zero).

If the amount of charge on the output sheet is zero (YES in step S810), the value of the adjustment dial 602 is an appropriate charge removal adjustment value, and thus the processing ends. If the sheet is still charged (NO in step S810), the processing returns to step S808. The user repeats the operation of adjusting a value indicated by the adjustment dial 602 and performing paper feed, obtaining an appropriate charge removal adjustment value that prevents the sheet from being charged.

In the present embodiment, the user directly sets the amount of charge measured by the separately prepared charge amount measurement device to the adjustment dial 602. However, the amount of charge automatically measured may be imported. For example, the charge amount measurement device may be connected to the charge removal device 200-3a via the external device I/F 506 to import the measurement value of the amount of charge and automatically set the measurement value on the adjustment dial 602.

Further, after the present processing ends, the printing device 100 may import, via the external I/F 202, data regarding a charge removal adjustment value for the sheet, on which an appropriate amount of charge is measured, corresponding to a product name not previously used. This configuration allows the printing device 100 to cause the operation unit 204 or the like to display a screen to be managed by the sheet data management unit 211, and then the data to be registered, making it possible to perform printing using the charge removal adjustment value for the sheet in the next printing.

### Processing of Selecting Adjustment Voltage Value (Charge Removal Device)

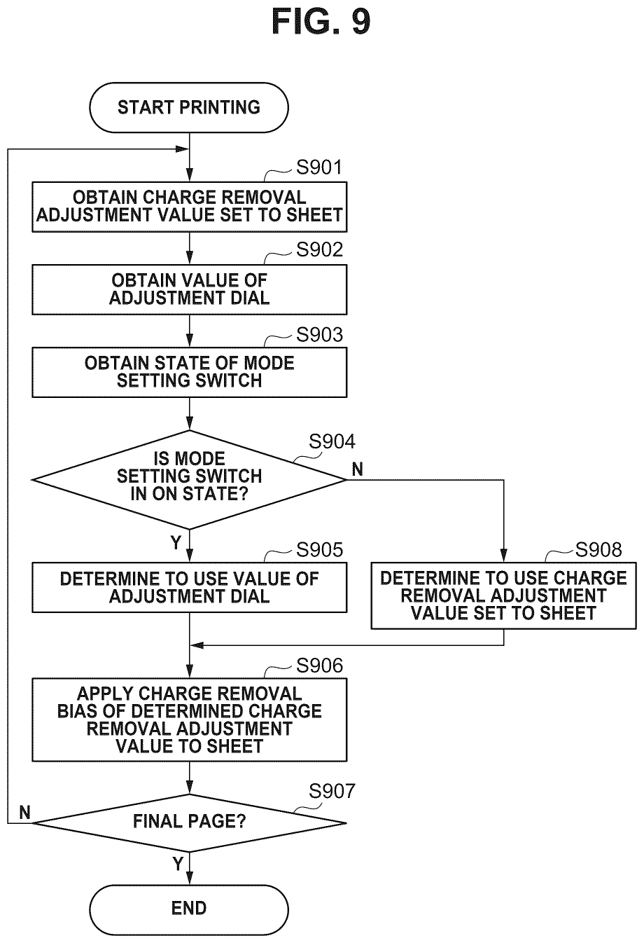

A method for selecting a charge removal adjustment value in the charge removal device 200-3a during printing and the control will now be described with reference to FIG. 9. This processing is performed by the control unit 501 loading a program stored in the ROM 504 into the RAM 505 to execute the program.

In step S901, when printing is started, the control unit 501 receives print information from the printing device 100 via the external device I/F 506. The print information includes a charge removal adjustment value set for the sheet.

In step S902, the control unit 501 obtains a value of the adjustment dial 602, which is set in the operation unit 502.

In step S903, the control unit 501 obtains a state of the mode setting switch 601 of the operation unit 502.

In step S904, the control unit 501 determines the obtained state of the mode setting switch 601. If the state of the mode setting switch 601 is at ON (YES in step S904), the processing proceeds to step S905. If the state of the mode setting switch 601 is at AUTO (NO in step S904), the processing proceeds to step S908.

### (In Case of ON)

In step S905, the control unit 501 determines to apply a charge removal bias of the charge removal adjustment value that is set to the adjustment dial 602 in the operation unit 502, and the processing proceeds to step S906.

Examples of a case where the charge removal adjustment value on the adjustment dial 602 is selected include the case of measuring the amount of charge on the sheet corresponding to a product name of which sheet properties are unknown via the user operation illustrated in FIG. 8 and then setting a charge removal adjustment value to the adjustment dial 602 to input the print job. This corresponds to a case where the procedure of the operations from step S804 to step S810 in FIG. 8 is performed.

### (In Case of AUTO)

In step S908, the control unit 501 determines to apply a charge removal bias of the charge removal adjustment value set for the sheet received from the printing device 100 via the external device I/F 506, and the processing proceeds to step S906.

Examples of a case where the charge removal adjustment value set for the sheet is selected include a case where printing is performed using a sheet corresponding to a product name registered in the printing device 100 in FIG. 8. This corresponds to a case where the procedure of the operations from YES in step S801 to step S803 in FIG. 8 is performed.

In step S906, the control unit 501 sets the determined charge removal adjustment value to the charge removal processing unit 503 to apply a charge removal bias of the set charge removal adjustment value to the sheet.

In step S907, the control unit 501 determines whether the current page is the final page of the print job. If the current page is not the final page (NO in step S907), the processing returns to step S901. The control unit 501 repeats the operations from steps S901 to S906 and the operation in step S908 until the final page of the print job. If the current page is the final page (YES in step S907), the processing ends.

In the present embodiment, the switching unit configured to switch the state of the mode setting switch 601 between two stages of ON and AUTO is used, but the configuration is not limited to the example. For example, switching control may be performed using a multi-stage switch provided with a mode setting switch and an adjustment dial.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-028108, which was filed on Feb. 25, 2025 and which is hereby incorporated by reference herein in its entirety.

What is claimed is:

1. An image forming apparatus comprising:
a printer unit configured to print an image on a sheet;
a control unit configured to cause a charge removal device to perform charge removal processing on the sheet with the image printed thereon by the printer unit, the charge removal device having an operation unit configured to be operable by a user; and
a storage device configured to store charge removal setting values each corresponding to one sheet type,
wherein the operation unit selects whether to use a first charge removal setting value set by the operation unit to perform the charge removal processing on the sheet with the image printed thereon by the printer unit or use a second charge removal setting value for the sheet with the image printed thereon, out of the charge removal setting values stored in the storage device, to perform the charge removal processing on the sheet with the image printed thereon by the printer unit.

2. The image forming apparatus according to claim 1, wherein, in a case where the operation unit selects to use the first charge removal setting value to perform the charge removal processing, the control unit causes the charge removal device to use the first charge removal setting value to perform the charge removal processing on the sheet with the image printed thereon by the printer unit, and in a case where the operation unit selects to use the second charge removal setting value to perform the charge removal processing, the control unit causes the charge removal device to use the second charge removal setting value to perform the charge removal processing on the sheet with the image printed thereon by the printer unit.

3. The image forming apparatus according to claim 1,
wherein the operation unit includes a charge removal setting unit and a selection unit, and
wherein the selection unit selects whether to use the first charge removal setting value set by the charge removal setting unit to perform the charge removal processing on the sheet with the image printed thereon by the printer unit or use the second charge removal setting value for the sheet with the image printed thereon, out of the charge removal setting values stored in the storage device, to perform the charge removal processing on the sheet with the image printed thereon by the printer unit.

4. The image forming apparatus according to claim 1, wherein each charge removal setting value is a voltage value for charge removal.

5. The image forming apparatus according to claim 3, wherein the selection unit is a switch.

6. The image forming apparatus according to claim 3, wherein the charge removal setting unit is a dial.

7. The image forming apparatus according to claim 1, wherein the charge removal setting values include a charge removal setting value for plain paper and a charge removal setting value for synthetic paper, and wherein the charge removal setting value for plain paper is different from the charge removal setting value for synthetic paper.

8. A method for controlling an image forming apparatus including a printer unit configured to print an image on a sheet and a control unit configured to cause a charge removal device to perform charge removal processing on the sheet with the image printed thereon by the printer unit, the charge removal device having an operation unit configured to be operable by a user, the method comprising:
storing charge removal setting values each corresponding to one sheet type in a storage device; and
selecting, by an operation of the operation unit, whether to use a first charge removal setting value set by the operation unit to perform the charge removal processing on the sheet with the image printed thereon by the printer unit or use a second charge removal setting value for the sheet with the image printed thereon, out of the charge removal setting values stored in the storage device, to perform the charge removal processing on the sheet with the image printed thereon by the printer unit.

9. A non-transitory computer-readable storage medium storing a program that causes a computer to execute a method for controlling an image forming apparatus including a printer unit configured to print an image on a sheet and a control unit configured to cause a charge removal device to perform charge removal processing on the sheet with the image printed thereon by the printer unit, the charge removal device having an operation unit configured to be operable by a user, the method comprising:
storing charge removal setting values each corresponding to one sheet type in a storage device; and
selecting, by an operation of the operation unit, whether to use a first charge removal setting value set by the operation unit to perform the charge removal processing on the sheet with the image printed thereon by the printer unit or use a second charge removal setting value for the sheet with the image printed thereon, out of the charge removal setting values stored in the storage device, to perform the charge removal processing on the sheet with the image printed thereon by the printer unit.
